(19) United States
(12) Patent Application Publication
(10) Pub. No.: US 2010/0039452 A1
(43) Pub. Date: Feb. 18, 2010

(54) METHOD FOR DRIVING A LIGHT SOURCE, LIGHT SOURCE DEVICE FOR PERFORMING THE METHOD, AND LIQUID CRYSTAL DISPLAY DEVICE HAVING THE LIGHT SOURCE DEVICE

(75) Inventors: Se-Ki Park, Gyeonggi-do (KR); Gi-Cherl Kim, Gyeonggi-do (KR); Si-Joon Song, Gyeonggi-do (KR)

Correspondence Address: Haynes and Boone, LLP;IP Section, 2323 Victory Avenue, SUITE 700, Dallas, TX, 75219, US

(73) Assignee: SAMSUNG ELECTRONICS CO., LTD., Gyeonggi-do (KR)

(21) Appl. No.: 12/407,478

(22) Filed: Mar. 19, 2009

(30) Foreign Application Priority Data
Aug. 12, 2008 (KR) 2008-78901

(51) Int. Cl. G09G 5/10; G09G 3/36

(52) U.S. Cl. 345/690; 345/88

(57) ABSTRACT

A light source device includes a light source part, a power supply part and a light source control part. The light source part includes a plurality of light sources that generates a plurality of color lights. The power supply part applies electric power to the light source part. The light source control part controls the electric power by sensing the light intensity of a portion of the color lights.

### PRIORITY STATEMENT

This application claims priority under 35 U.S.C. §119 to Korean Patent Application No. 2008-78901, filed on Aug. 12, 2008 in the Korean Intellectual Property Office (KIPO), the contents of which are herein incorporated by reference in their entirety.

### BACKGROUND OF THE INVENTION

1. Field of the Invention

Example embodiments of the present invention relate to a method for driving a light source, a light source device for performing the method, and a liquid crystal display (LCD) device having the light source device. More particularly, example embodiments of the present invention relate to a method for driving a light source, a light source device for performing the method, and an LCD device having the light source device for controlling the light intensity of color lights.

2. Description of the Related Art

Generally, a liquid crystal display (LCD) device displays an image using electrical and optical characteristics of liquid crystal. LCD devices have various characteristics such as smaller thickness, lighter weight, lower power consumption and lower driving voltage than other types of display devices, and thus LCD devices are widely used in various fields. The LCD device includes an LCD panel displaying an image using light transmissivity of the liquid crystal and a backlight assembly disposed under the LCD panel to provide light to the LCD panel.

The LCD panel includes a first substrate having a plurality of thin-film transistors (TFTs) disposed in a matrix arrangement, a second substrate facing the first substrate and a liquid crystal layer interposed between the first substrate and the second substrate.

The backlight assembly includes a light source that generates the light for displaying the image on the LCD panel. For example, the light source is a cold cathode fluorescent lamp (CCFL), a hot cathode fluorescent lamp (HCFL), a light-emitting diode (LED), etc. Recently, a plurality of the LEDs have been used, because the LEDs have lower power consumption and higher color reproducibility

The LCD device further includes a driving part and a controlling part for driving the backlight assembly. The controlling part controls the driving part using a pulse width modulation control method for controlling the light intensity of the LEDs based on characteristics of high-speed driving. The pulse width modulation control method provides the LEDs with a constant current by generating pulses, comparing pulse widths and modulating pulse widths.

When the LEDs include red LEDs, green LEDs and blue LEDs, white light may not be balanced, because luminance variations of the LEDs caused by time differences from each other.

The backlight assembly detects light intensity to solve the unbalance of the white light using a red color sensor, a green color sensor and a blue color sensor. The red color sensor is sensible for wavelength of the light generated from the red LEDs. The green color sensor is sensible for wavelength of the light generated from the green LEDs. The blue color sensor is sensible for wavelength of the light generated from the blue LEDs. That is, the light intensities of red light, green light and blue light are sensed by the red, green and blue color sensors, respectively, and then, signals corresponding to the sensed light intensity are applied to the controlling part.

The controlling part compares the sensed light intensity with light information data stored in a look-up table (LUT) and calculates compensated values. The controlling part controls luminance of the red, green and blue lights based on the compensated values by feeding back pulse width modulation (PWM) signals of each of the red, green and blue lights to the driving part.

However, accurate control may be impossible, due to mutual spectrum interference between the red, green and blue lights that are sensed by the red, green and blue color sensors, respectively.

### SUMMARY OF THE INVENTION

Example embodiments of the present invention provide a method for driving a light source capable of decreasing an accidental error of controlling light intensity that is generated by mutual interference between color lights.

Example embodiments of the present invention also provide a light source device for performing the above-mentioned method.

Example embodiments of the present invention also provide a liquid crystal display (LCD) device having the light source device.

According to one aspect of the present invention, a method for driving a light source is provided as follows. Electric power is applied to a plurality of light sources generating a plurality of color lights. A light-sensing signal is outputted by sensing the light intensity of a portion of the color lights. An application of the electric power to the light sources is controlled based on the light-sensing signal.

The application of the electric power may be controlled as follows. A light-sensing-amplifying signal may be outputted by amplifying the light-sensing signal. A first light-sensing data may be outputted by analog-to-digital converting the light-sensing-amplifying signal. A second light-sensing data of a remainder of the color lights may be outputted by calculating the first light-sensing data, the remainder of the color lights having the light intensities that are non-sensed. The first and second light-sensing data may be compared with light information data to control the electric power applied to the light sources, the light information data being externally provided.

The light sources may include red light-emitting diodes (LEDs), green LEDs and blue LEDs and the light-sensing signal of the sensed portion of the color lights may correspond to a red light-sensing signal generated by sensing the light intensity of red light, and the first light-sensing data may correspond to red light-sensing data.

The second light-sensing data of the remainder of the color lights may correspond to green light-sensing data. The green light-sensing data may be calculated by the following equation, GD=RD×(b/a), RD represents the red light-sensing data outputted based on the red light-sensing signal, GD represents the green light-sensing data, and a, b and c represent a mixture ratio of the red light, green light, blue light to generate white light.

The second light-sensing data of the remainder of the color lights may correspond to blue light-sensing data. The blue light-sensing data may be calculated by the following equation, BD=RD×(c/a), RD represents the red light-sensing data outputted based on the red light-sensing signal, BD represents the blue light-sensing data, and a, b and c represent a mixture ratio of the red light, green light, blue light to generate white light.

The light sources may include red LEDs, green LEDs and blue LEDs, and the light-sensing signal of the sensed portion of the color lights may correspond to a red light-sensing signal generated by sensing the light intensity of red light and a blue light-sensing signal generated by sensing the light intensity of blue light, and the first light-sensing data may correspond to red light-sensing data and blue light-sensing data.

The electric power may be controlled by modulating pulse widths of currents that are applied to the light sources. The electric power may be also controlled by adjusting the level of currents that are applied to the light sources.

According to one aspect of the present invention, a light source device includes a light source part, a power supply part and a light source control part. The light source part includes a plurality of light sources that generates a plurality of color lights. The power supply part applies electric power to the light source part. The light source control part controls the electric power by sensing the light intensity of a portion of the color lights.

The light source control part may include at least one color sensor, an amplifier, an analog-digital converter (ADC), a calculating part and a controller. The color sensor may output a light-sensing signal by sensing the light intensity of the portion of the color lights. The amplifier may output a light-sensing-amplifying signal by amplifying the light-sensing signal. The ADC may output first light-sensing data by analog-to-digital converting the light-sensing-amplifying signal. The calculating part may output second light-sensing data of a remainder of the color lights, the remainder of the color lights having the light intensities that are non-sensed. The controller may control the electric power by comparing the first and second light-sensing data with light information data that is provided from the exterior.

The light sources may include red LEDs, green LEDs and blue LEDs. The color sensor may correspond to a red color sensor that senses the light intensity of red light, the light-sensing signal may correspond to a red light-sensing signal, and the first light-sensing data may correspond to red light-sensing data.

The calculating part may output green light-sensing data and blue light-sensing data that are calculated by the following equation, GD=RD×(b/a) and BD=RD×(c/a), RD represents the red light-sensing data outputted based on the light intensity of the red light sensed by the red color sensor, GD represents the green light-sensing data, BD represents blue light-sensing data, and a, b and c represent a mixture ratio of the red light, green light, blue light to generate white light.

The color sensor may correspond to a red color sensor that senses the light intensity of red light and a blue color sensor that senses the light intensity of blue light. The light-sensing signal may correspond to a red light-sensing signal and a blue light-sensing signal and the first light-sensing data may correspond to red light-sensing data and blue light-sensing data.

The controller may control the electric power by modulating pulse widths of currents that are applied to the light sources. The controller may control the electric power by adjusting the level of currents that are applied to the light sources.

The color sensor may be disposed on a center of the light source part. The light source part may be divided into a plurality of light-emitting blocks and the color sensor may be disposed on a center of each of the light-emitting blocks. The color sensor may be disposed on at least one of edges, side portions, upper portion and lower portion of the light source part.

According to one aspect of the present invention, an LCD device may include a light source part, a power supply part, a light source control part, a receiving container and an LCD panel. The light source part includes a plurality of light sources that generates a plurality of color lights. The power supply part applies electric power to the light source part. The light source control part controls the electric power by sensing the light intensity of a portion of the color lights. The receiving container receives the light source part. The LCD panel includes a first substrate, a second substrate and a liquid crystal layer interposed between the first and second substrates to display an image using the color lights.

According to the method for driving the light source and the light source device of the present invention, the light intensity of a portion of the color lights is sensed, so that an accidental error of controlling the light intensity may be decreased and the light intensity may be accurately controlled.

### BRIEF DESCRIPTION OF THE DRAWINGS

The above and other features and advantages of the present invention will become more apparent by describing in detailed example embodiments thereof with reference to the accompanying drawings, in which:

FIG. 1 is an exploded perspective view illustrating a liquid crystal display (LCD) device in accordance with one embodiment of the present invention;

FIG. 2 is a plan view illustrating the light source part of FIG. 1;

FIG. 3 is a block diagram describing the LCD device illustrated in FIG. 1;

FIG. 4 is a block diagram describing the light source device illustrated in FIG. 3;

FIGS. 5A and 5B are graphs showing a relationship between currents of light-emitting diodes (LEDs) and luminance;

FIGS. 6A, 6B and 6C are graphs showing a quality deterioration of LEDs according to time;

FIG. 7 is a flowchart showing a method for driving a light source in accordance with one embodiment of the present invention; and

FIG. 8 is graph showing light-receiving spectrums of red, green and blue LEDs.

### DETAILED DESCRIPTION OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

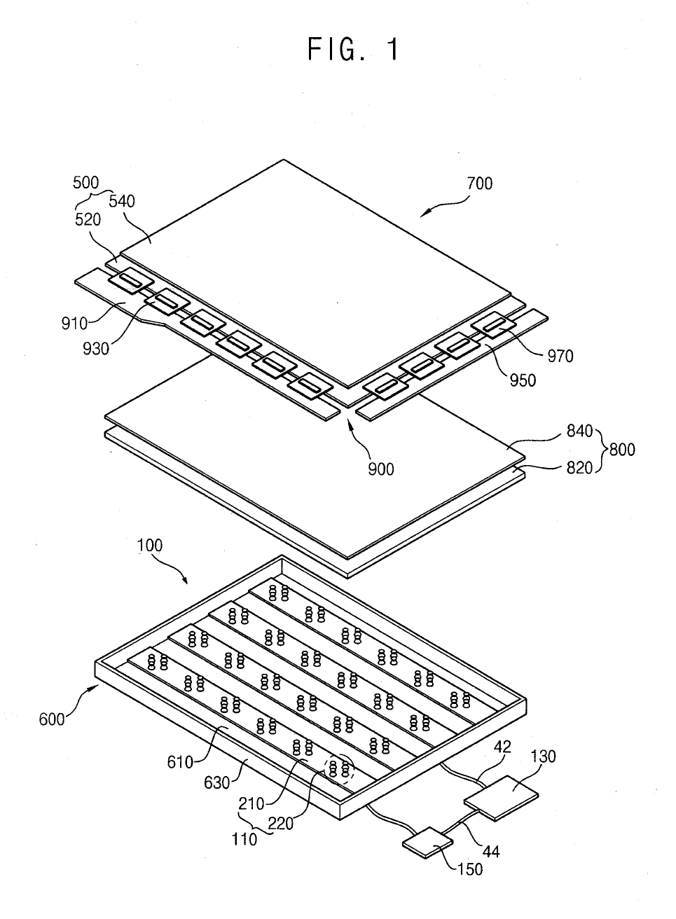

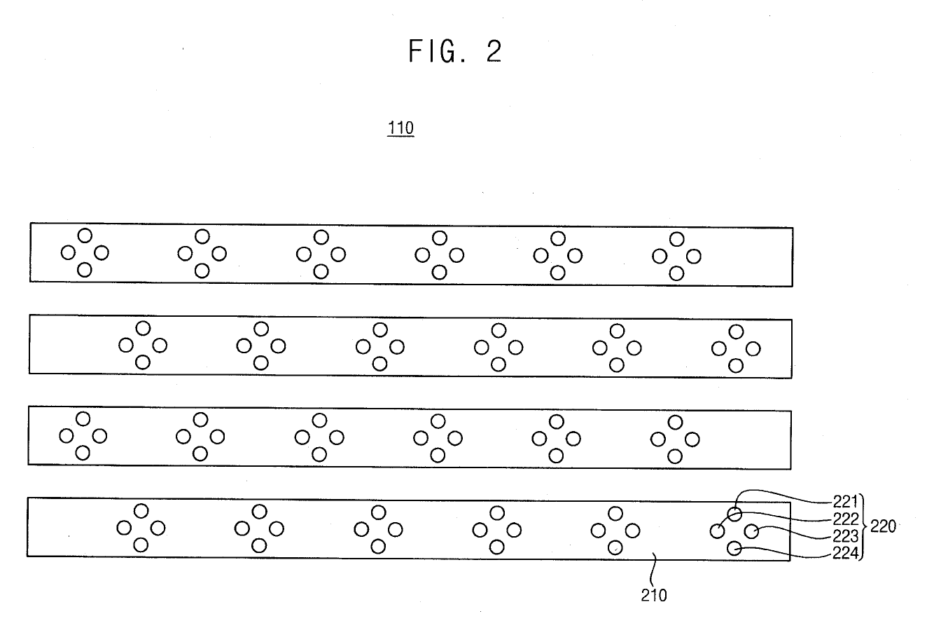

FIG. 1 is an exploded perspective view illustrating a liquid crystal display (LCD) device in accordance with one embodiment of the present invention. FIG. 2 is a plan view illustrating the light source part of FIG. 1.

Referring to FIGS. 1 and 2, an LCD device includes a light source device 100, a receiving container 600 and a display unit 700.

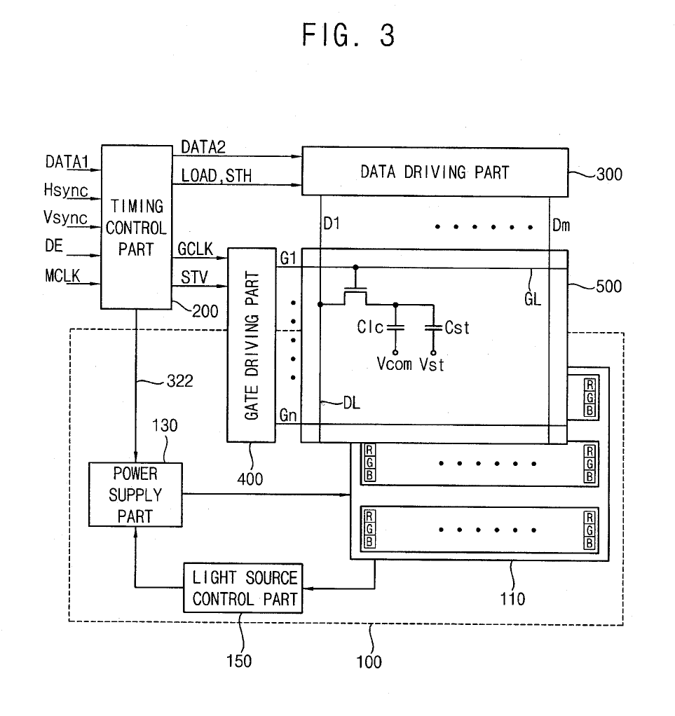

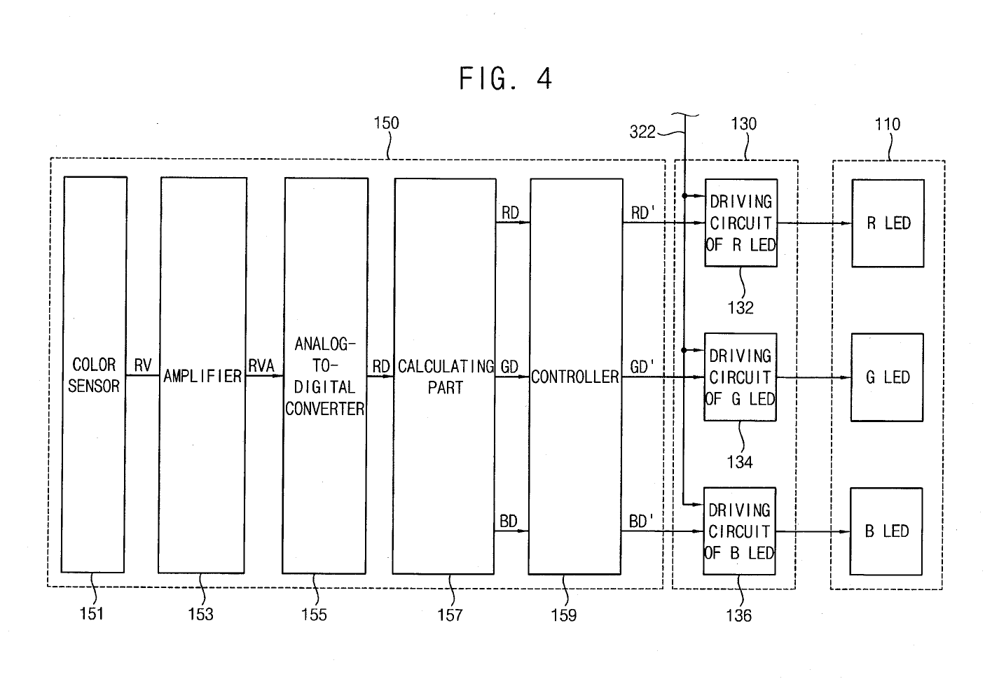

The light source device 100 includes a light source part 110, a power supply part 130 and a light source control part 150. The light source device 100 will be described in detail with FIGS. 3 and 4.

The receiving container 600 includes a bottom portion 610 and a side portion 630 protruded from sides of the bottom portion 610 to define a receiving space, thereby receiving the light source part 110. For example, the receiving container 600 may include a strong metal resistant to deformation.

The light source part 110 is disposed on the bottom portion 610 of the receiving container 600. The light source part 110 includes a plurality of circuit substrates 210 and a plurality of optical clusters 220 arranged on each of the circuit substrates 210.

The light source part 110 is disposed on the bottom portion 610 of the receiving container 600 to function as a backlight assembly. Each of the optical clusters 220 includes a plurality of light-emitting elements that generates various lights. At this embodiment of the present invention, each of the optical clusters 220 may include a red light-emitting element 221, a first green light-emitting element 222 and a blue light-emitting element 224. Each of the optical clusters 220 may further include a second green light-emitting element 223. The red light-emitting element 221 generates red light. Each of the first and second green light-emitting elements 222 and 223 generates green light. The blue light-emitting element 224 generates blue light. Each of the light-emitting elements includes a light-emitting diode (LED, not shown) and an optical lens. The LED generates the light. The optical lens surrounds the LED to guide the light generated from the LED.

For example, the red light-emitting element 221 includes a red LED and a first optical lens. The red LED generates the red light, and the first optical lens surrounds the red LED to diffuse the red light. The first green light-emitting element 222 includes a first green LED and a second optical lens. The first green LED generates a first green light, and the second optical lens surrounds the first green LED to diffuse the first green light. The second green light-emitting element 223 includes a second green LED and a third optical lens. The second green LED generates the second green light, and the third optical lens surrounds the second green LED to diffuse the second green light. The blue light-emitting element 224 includes a blue LED and a fourth optical lens. The blue LED generates the blue light, and the fourth optical lens surrounds the blue LED to diffuse the blue light.

In FIGS. 1 and 2, each of the optical clusters 220 includes one red LED, two green LEDs and one blue LED. However, each of the optical clusters 220 may also include one red LED, one green LED and one blue LED.

The circuit substrates 210 are spaced apart from each other by a constant distance, and are arranged substantially in parallel with each other. The optical clusters 220 are alternately arranged on adjacent circuit substrates 210 of the light source part 110 as a zigzag shape. For example, the optical clusters 220 on each of the circuit substrates 210 are between the optical clusters 220 of adjacent circuit substrates 210, such that a column of optical clusters 220 only includes optical clusters 220 from every other row. Alternate arrangements of the optical clusters 220 and the circuit substrates 210 would also be within the scope of these embodiments.

For example, the optical clusters 220 may be arranged on each of the circuit substrates 210, and the circuit substrates 210 may be positioned on the bottom portion 610 within the receiving space of the receiving container 600. Alternatively, the circuit substrates 210 may be disposed on an outer surface of the receiving container 600, and only the optical clusters 220 may be inserted into the receiving space of the receiving container 600, such as through openings formed in the bottom portion 610.

The display unit 700 includes an LCD panel 500 and a driving circuit member 900. The LCD panel 500 displays an image using the light generated from the light source part 110. The driving circuit member 900 drives the LCD panel 500.

The LCD panel 500 includes a first substrate 520, a second substrate 540, and a liquid crystal layer (not shown). The second substrate 540 faces the first substrate 520, and is combined with the first substrate 520. The liquid crystal layer is interposed between the first and second substrates 520 and 540.

The first substrate 520 includes a plurality of thin-film transistors (TFTs) arranged in a matrix shape. The TFTs are switching elements. For example, the first substrate 520 includes a glass substrate or other transparent insulating substrate. A source electrode and a gate electrode of each of the TFTs are electrically connected to data and gate lines that are formed on the first substrate 520, respectively. A drain electrode of each of the TFTs is electrically connected to a pixel electrode including a transparent conductive material.

The second substrate 540 includes a color filter substrate having a plurality of red, green, and blue color filters. The red, green, and blue color filters are formed on the second substrate 540 as a thin film shape. For example, the second substrate 540 includes a glass substrate or other transparent insulating substrate. A common electrode including a transparent conductive material is formed on the second substrate 540.

When a voltage is applied to the gate electrode of each of the TFTs of the LCD panel 500, the TFT is turned on so that an electric field is formed between the pixel electrode and the common electrode. Liquid crystals of the liquid crystal layer interposed between the first and second substrates 520 and 540 vary arrangement in response to the electric field applied thereto, and light transmittance of the liquid crystal layer is changed, thereby displaying the image of a predetermined gray scale.

The driving circuit member 900 includes a data printed circuit board (PCB) 910, a gate PCB 950, a data driving circuit film 930, and a gate driving circuit film 970. The data PCB 910 applies a data driving signal to the LCD panel 500. The gate PCB 950 applies a gate driving signal to the LCD panel 500. The data PCB 910 is electrically connected to the LCD panel 500 through the data driving circuit film 930. The gate PCB 950 is electrically connected to the LCD panel 500 through the gate driving circuit film 970.

For example, each of the data driving circuit film 930 and the gate driving circuit film 970 includes a tape carrier package (TCP) or a chip-on-film (COF). Alternatively, an auxiliary signal line (not shown) may be formed on the LCD panel 500 and the gate driving circuit film 970 so that the gate PCB 950 may be omitted.

In addition, a power supply part 130 applies an adjusted driving voltage to the light source part 110 based on a light-sensing signal that is generated from a color sensor. The light-sensing signal that is generated from the color sensor is applied to the light source part 110 through a second power supplying line 44.

The LCD device may further include an optical member 800 on an upper portion of the light source device 100. The optical member 800 is spaced apart from the LEDs to mix red, green, and blue lights.

The optical member 800 may include a diffusion plate 820 and optical sheets 840. The diffusion plate 820 diffuses the light generated from the LEDs. The optical sheets 840 are on the diffusion plate 820.

The diffusion plate 820 diffuses the light generated from the LEDs to increase luminance uniformity of the light. The diffusion plate 820 may be substantially plate-shaped having a predetermined thickness. The diffusion plate 820 may include a matrix and a diffusing agent. Examples of the matrix that can be used for the diffusion plate 820 include polymethylmethacrylate (PMMA), polycarbonate (PC), etc. The diffusing agent is in the matrix to diffuse the light.

The optical sheets 840 guide the diffused light to improve optical characteristics. The optical sheets 840 may include a brightness enhancement sheet that guides the diffused light in a front direction of the LCD device to increase luminance when viewed on a plane. In addition, the optical sheets 840 may further include a diffusion sheet that diffuses the guided light having passed through the diffusion plate 820. Alternatively, the optical sheets 840 may further include various optical sheets to improve the optical characteristics.

A light guiding member (not shown) may be under the optical member 800. The light guiding member may be spaced apart from the light source device 100. The light guiding member mixes the red, green, and blue lights generated from the light source device 100 to generate white light. The light guiding member includes a transparent material. Examples of the transparent material that may be used for the light guiding member include PMMA, PC, etc.

FIG. 3 is a block diagram describing the LCD device illustrated in FIG. 1.

Referring to FIG. 3, the LCD device includes a timing control part 200, a data driving part 300, a gate driving part 400, an LCD panel 500, and a light source device 100.

The light source device 100 is disposed on a lower surface of the LCD panel 500 to supply the LCD panel 500 with light. The light source device 100 functions as a backlight assembly for the LCD panel 500.

The timing control part 200 receives a first data signal DATA1, synchronizing signals Hsync and Vsync, a data enable signal DE, and a main clock MCLK from an external device such as a graphic controller. The synchronizing signals Hsync and Vsync may include a horizontal synchronizing signal Hsync and a vertical synchronizing signal Vsync.

The timing control part 200 applies second data signal DATA2 and data driving signals LOAD and STH to the data driving part 200. The data driving signals LOAD and STH control an output of the second data signal DATA2. The data driving signals LOAD and STH include a load signal LOAD and a horizontal start signal STH. The load signal LOAD controls loading of the second data signal DATA2. The horizontal start signal STH controls starting of activation of horizontal lines.

The timing control part 200 applies gate driving signals GCLK and STV to the gate driving part 400. The gate driving signals GCLK and STV includes a gate clock GCLK and a vertical start signal STV. The vertical start signal STV controls the starting of a first frame.

The timing control part 200 applies a current control signal 322 to the light source device 100 in response to the vertical start signal STV.

The data driving part 300 changes the second data signal DATA2 from the timing control part 200 into data voltages D1, D2, . . . , Dm, wherein m is a natural number or a multiple number of three. The data voltages D1, D2, . . . , Dm are pixel voltages. The data voltages D1, D2, . . . , Dm are applied to data lines DL of the LCD panel 500, respectively.

The gate driving part 400 applies gate signals G1, G2, . . . , Gn to gate lines GL of the LCD panel 500 based on the gate driving signal GCLK and STV, in sequence. The gate signals G1, G2, . . . , Gn activate the gate lines of the LCD panel 500, wherein n is a natural number.

The LCD panel 500 includes an array substrate (not shown), an opposite substrate (not shown), and a liquid crystal layer (not shown). The opposite substrate faces the array substrate. The liquid crystal layer is interposed between the array substrate and the opposite substrate. For example, the array substrate includes the gate lines GL, the data lines DL, and a plurality of pixel parts (not shown). The gate lines GL transmit the gate signals G1, G2, . . . , Gn. The gate signals may be scan signals. The data lines DL transmit the data voltages D1, D2, . . . , Dm. The data lines DL may be source lines. The pixel parts are formed in regions defined by the gate and data lines GL and DL adjacent to each other.

Each of the pixel parts includes a switching element and a pixel electrode (not shown) electrically connected to the switching element. The opposite substrate includes a transparent substrate, a common electrode (not shown), and a color filter layer (not shown). The common electrode is formed on the transparent substrate, and faces the pixel electrode.

The light source device 100 includes a light source part 110, a power supply part 130 and a light source control part 150.

The light source part 110 includes a plurality of light sources that generate a plurality of color lights. The light source part 110 is disposed on a rear surface of the LCD panel 500 to function as a backlight assembly. For example, the plurality of color lights may be red, green, and blue lights and the plurality of light sources may be red LEDs, green LEDs and blue LEDs.

At least three the red, green and blue LEDs form one optical cluster and exit the white light. The plurality of optical clusters may be arranged in parallel and form light-emitting blocks. Each of the optical clusters may include one red LED, one green LED and one blue LED. Each of the optical clusters may also include one red LED, two green LEDs and one blue LED.

The power supply part 130 applies electric power to the light source part 110 based on the current control signal 322. The power supply part 130 also applies a gate on voltage VON and a gate off voltage VOFF (not shown) to the gate driving part 400. Levels of the gate on voltage VON and the gate off voltage VOFF are determined to turn on and turn off the switching elements of the LCD panel 500. The switching elements may include amorphous silicon (a-Si) TFTs.

The power supply part 130 may be divided into three parts that a first part applying the electric power to the red LEDs, a second part applying the electric power to the green LEDs and a third part applying the electric power to the blue LEDs.

The light source control part 150 senses the light intensity of a portion of the color lights generated by the light source part 110 and controls the electric power that applied to the light source part 110 from the power supply part 130.

FIG. 4 is a block diagram describing the light source device illustrated in FIG. 3.

Referring to FIGS. 3 and 4, the light source device 100 includes the light source part 110, the power supply part 130 and the light source control part 150.

The light source part 110 includes a plurality of light sources that generate a plurality of color lights. For example, the plurality of color lights may be red, green, and blue lights and the plurality of light sources may be red LEDs, green LEDs and blue LEDs.

The power supply part 130 may include a driving circuit of the red LEDs 132, a driving circuit of the green LEDs 134 and a driving circuit of the blue LEDs 136.

The light source control part 150 includes a color sensor 151, an amplifier 153, an analog-digital converter (ADC) 155, a calculating part 157 and a controller 159.

The color sensor 151 outputs a light-sensing signal by sensing the light intensity of the portion of the color lights. The color sensor 151 does not sense the light intensity of the green light among the red, green and blue lights. That is, the color sensor 151 includes only red color sensor that merely senses the red light and detects the light intensity of the red light. Alternatively, the color sensor 151 includes the red color sensor sensing the red light and blue color sensor sensing the blue light.

Hereinafter, the embodiment of the color sensor 151 including only red color sensor will be explained. The color sensor 151 may be one or more than two. For example, the color sensor 151 may be disposed on a center of the light source part 110. Alternatively, the color sensor 151 may be disposed on the light-emitting blocks, that is, a center of each of the circuit substrates 210. The color sensor 151 may be disposed on at least one of edges, side portions, upper portion and lower portion of the light source part 110.

The color sensor 151 outputs a red light-sensing signal RV to the amplifier 153 by sensing the light intensity of the red light emitted from the red LEDs.

The amplifier 153 outputs a red light-sensing-amplifying signal RVA by amplifying the red light-sensing signal RV outputted from the color sensor 151. The amplifier 153 may include an operational amplifier low-pass filtering the signal. The amplifier 153 provides the red light-sensing-amplifying signal RVA to the ADC 155.

The ADC 155 outputs a red light-sensing data RD by analog-to-digital converting the red light-sensing-amplifying signal RVA. The red light-sensing data RD may be hexadecimal data. The ADC 155 outputs the red light-sensing data RD to the calculating part 157.

The calculating part 157 outputs light-sensing data of remainder of the color lights of which light intensity are not sensed based on the red light-sensing data RD. At this embodiment of the present invention, a green light-sensing data GD and a blue light-sensing data BD are outputted based on the red light-sensing data RD.

The green light-sensing data GD and the blue light-sensing data BD are calculated by the following Equation 1.

GD=RD*(b/a)

BD=RD*(c/a) Equation 1

In Equation 1, a, b and c represent a mixture ratio of the red light, the green light, the blue light to generate the white light. Value of a, b and c are decided through color coordinate and luminance represented in manufacturing progress of the light source device.

For example, when the color coordinate of the white light is White(x, y)=0.282, 0.290, the mixture ratio of the red light, green light, blue light may be a:b:c=1:1.77:1.51.

The calculating part 157 may output the green light-sensing data GD and the blue light-sensing data BD by Equation 1 based on the red light-sensing data RD, although the light intensity of the green light and the blue light are not sensed. The calculating part 157 outputs the red light-sensing data RD, the green light-sensing data GD and the blue light-sensing data BD to the controller 159.

The controller 159 outputs control signals RD′, GD′ and BD′ to the power supply part 130 by comparing the red light-sensing data RD, the green light-sensing data GD and the blue light-sensing data BD with light information data stored in the look-up table of the exterior. The power supply part 130 controls the electric power applied to the light source part 110 based on the control signals RD′, GD′ and BD′.

The controller 159 may control the electric power by modulating pulse widths of currents that are applied to the light source part 110. The controller 159 may control the electric power applied to the driving circuit of the red LEDs 132, the driving circuit of the green LEDs 134 and the driving circuit of the blue LEDs 136, respectively.

The controller 159 may also control the electric power by adjusting the level of currents that are applied to the light source part 110. However, the control by adjusting the level of currents is possible within a scope in which luminance linearity of the red, blue and green LEDs according to the level of currents is ensured.

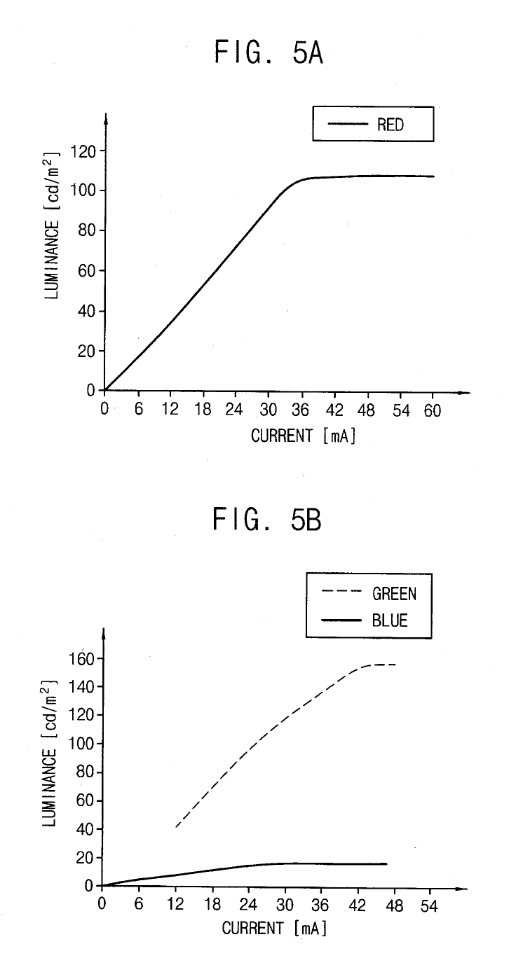

FIGS. 5A and 5B are graphs showing a relationship between currents of LEDs and luminance.

Referring to FIG. 5A, luminance variation of the red LEDs gets a steady state at about 36 mA. The red LEDs have linearity luminance of a relationship between currents and luminance below about 36 mA.

Referring to FIG. 5B, luminance variation of the green LEDs gets a steady state at about 42 mA and luminance variation of the blue LEDs gets a steady state at about 30 mA.

That is, red, green and blue LEDs have the linearity luminance of a relationship between currents and luminance below about 30 mA. Therefore, when the controller 159 controls the electric power by adjusting the level of currents that are applied to the LEDs, a range of the adjusted level of currents may be from about 5 mA to about 30 mA.

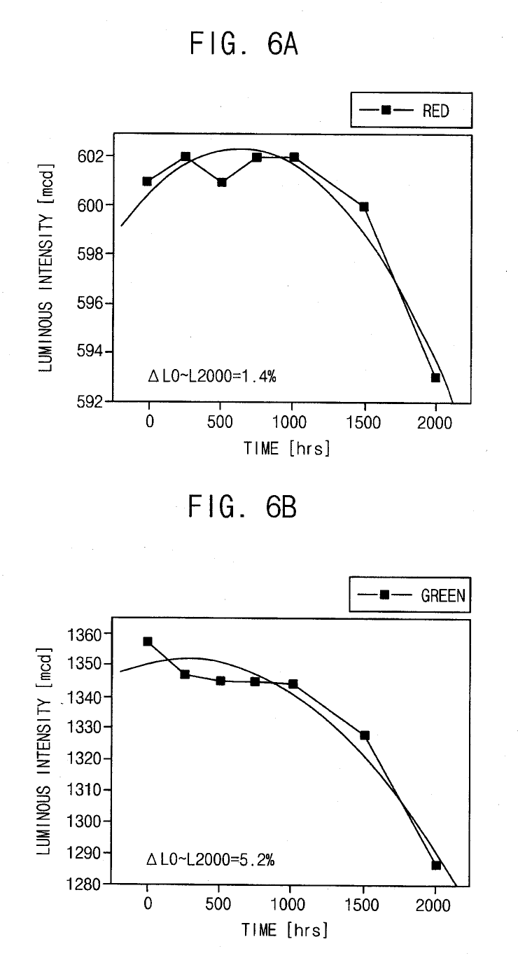

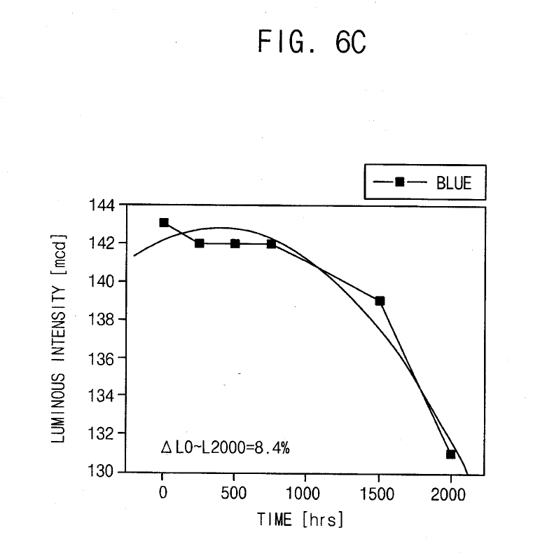

FIG. 6A is graph showing a quality deterioration of red LEDs according to time. FIG. 6B is graph showing a quality deterioration of green LEDs according to time. FIG. 6C is graph showing a quality deterioration of blue LEDs according to time.

FIGS. 6A, 6B and 6C are obtained experimental data when one red LED, one green LED and one blue LED define a optical cluster and fifty optical clusters receive about 80 mA in about 80° C. for about 2000 hours.

Referring to FIG. 6A, luminous intensity of the red light generated during initial driving period measures about 601 mcd, the luminous intensity of the red light after 250 hours measures about 602 mcd and the luminous intensity of the red light after about 2000 hours measures about 593 mcd.

A quality deterioration ratio of the red LEDs represents about 1.4%, because the maximum value of the luminous intensity of the red light is about 602 mcd and the minimum value is about 593 mcd.

Referring to FIG. 6B, luminous intensity of the green light generated during initial driving period measures about 1345 mcd and the luminous intensity of the green light after about 2000 hours measures about 1285 mcd. A quality deterioration ratio of the green LEDs represents about 5.2%, because the maximum value of the luminous intensity of the green light is about 1345 mcd and the minimum value is about 1285 mcd.

Referring to FIG. 6C, luminous intensity of the blue light generated during initial driving period measures about 143 mcd and the luminous intensity of the blue light after about 2000 hours measures about 131 mcd. A quality deterioration ratio of the blue LEDs represents about 8.4%, because the maximum value of the luminous intensity of the blue light is about 143 mcd and the minimum value is about 131 mcd.

Referring to FIGS. 6A, 6B and 6C, the quality deterioration ratio of the red, green and blue LEDs according to time are different each other. The quality deterioration ratio difference of the red, green and blue LEDs may be generated from material difference of a substrate for the LEDs or from material difference and composition difference of 3-5 compound semiconductor of active layer for LEDs.

However, the experimental data rapidly progresses in a high temperature, that is, about 80° C. so that the quality deterioration slowly progresses in a normal temperature, that is, about 25° C. Therefore, the controller 159 may more accurately control by compensating the electric power applied to the light source part 110 based on characteristics of the quality deterioration of the red, green and blue LEDs according to time.

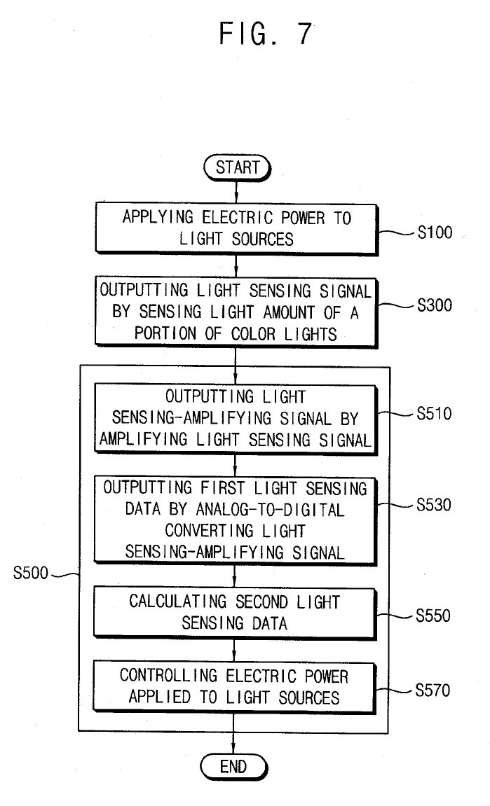

FIG. 7 is a flowchart showing a method for driving a light source in accordance with one embodiment of the present invention.

Referring to FIGS. 3, 4 and 7, a method for driving a light source is provided as follows. A plurality of light sources receives electric power (step S100) and generates a plurality of color lights. A light-sensing signal is outputted by sensing the light intensity of a portion of the color lights (step S300). The electric power applied to the light sources is controlled based on the light-sensing signal (step S500).

For example, the plurality of color lights may be red, green, and blue lights and the plurality of light sources may be red LEDs, green LEDs and blue LEDs.

At this embodiment of the present invention, the step S300 outputs the red light-sensing signal RV by merely sensing the light intensity of red light.

The step S500 outputs a red light-sensing-amplifying signal RVA by amplifying the red light-sensing signal RV (step S510) and outputs a red light-sensing data RD by analog-to-digital converting the red light-sensing-amplifying signal RVA (step S530).

Then, the green light-sensing data GD and the blue light-sensing data BD of which light intensity are not sensed are outputted by calculation (step S550). The green light-sensing data GD and the blue light-sensing data BD may be outputted by the equation 1.

The green light-sensing data GD and the blue light-sensing data BD may be outputted based on the red light-sensing data RD, although green color sensor and blue color sensor are not used.

The power supply applied to the light sources is controlled by comparing the red light-sensing data RD, the green light-sensing data GD and the blue light-sensing data BD with light information data stored in the look-up table of the exterior (step S570).

The control of the electric power may be accomplished by modulating pulse widths of currents that are applied to the LEDs. The control of the electric power may be accomplished by dividing into a driving circuit of the red LEDs, a driving circuit of the green LEDs and a driving circuit of the blue LEDs, respectively.

The control of the electric power may be also accomplished by adjusting the level of currents that are applied to the LEDs. However, the control by adjusting the level of currents is possible within a scope in which luminance linearity of the red, green and blue LEDs according to the level of currents is ensured.

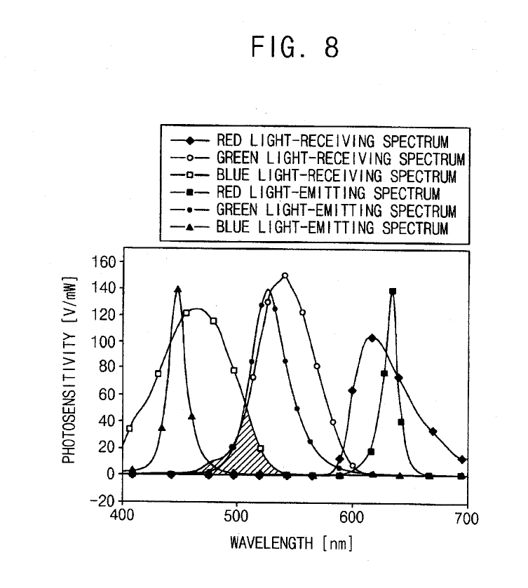

FIG. 8 is graph showing light-receiving spectrums of red, green and blue LEDs.

Lines connected by full figures represent light-emitting spectrum of red, green and blue LEDs. Lines connected by empty figures represent light-receiving spectrum of the red, green and blue LEDs. A portion that the light-receiving spectrum of green color sensor and the light-receiving spectrum of blue color sensor are overlapped each other is represented by oblique line in FIG. 8.

Referring to FIG. 8, the light-receiving spectrums of the green color sensor and the blue color sensor are partially overlapped. Mutual interference of detecting light intensity is generated from overlapping the light-receiving spectrums of the green color sensor and the blue color sensor. Thus, when the electric power is controlled by detecting the light intensity of red light, green light and blue light using the red, green and blue color sensors, the electric power may not be accurately controlled.

Therefore, an accidental error of controlling light intensities may be decreased so that the electric power is controlled by using merely the red color sensor or the red and blue color sensors, not using the green color sensor according to the present invention.

As described above, a method for driving a light source and a light source device for performing the method according to the present invention may be decreased the accidental error generated from overlapping the light-receiving spectrums of color lights and may accurately control the electric power applied to the light source by sensing the light intensity of a portion of the color lights.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method for driving a light source, the method comprising:
applying electric power to a plurality of light sources generating a plurality of color lights;
outputting a light-sensing signal by sensing the light intensity of a portion of the color lights; and
controlling application of the electric power to the light sources based on the light-sensing signal.

2. The method of claim 1, wherein controlling the application of the electric power comprises:
outputting a light-sensing-amplifying signal by amplifying the light-sensing signal;
outputting first light-sensing data by analog-to-digital converting the light-sensing-amplifying signal;
outputting second light-sensing data of a remainder of the color lights by calculating the first light-sensing data, the remainder of the color lights having the light intensities that are non-sensed; and
comparing the first and second light-sensing data with light information data to control the electric power applied to the light sources, the light information data being externally provided.

3. The method of claim 2, wherein the light sources include red light-emitting diodes (LEDs), green LEDs and blue LEDs,
and wherein the light-sensing signal of the sensed portion of the color lights corresponds to a red light-sensing signal generated by sensing the light intensity of red light, and the first light-sensing data corresponds to red light-sensing data.

4. The method of claim 3, wherein the second light-sensing data of the remainder of the color lights correspond to green light-sensing data, the green light-sensing data being calculated by the following equation:
GD=RD×(b/a)
wherein RD represents the red light-sensing data outputted based on the red light-sensing signal, GD represents the green light-sensing data, and a, b and c represent a mixture ratio of the red light, green light, blue light to generate white light.

5. The method of claim 3, wherein the second light-sensing data of the remainder of the color lights correspond to blue light-sensing data, the blue light-sensing data being calculated by the following equation:
BD=RD×(c/a)
wherein RD represents the red light-sensing data outputted based on the red light-sensing signal, BD represents the blue light-sensing data, and a, b and c represent a mixture ratio of the red light, green light, blue light to generate white light.

6. The method of claim 2, wherein the light sources include red LEDs, green LEDs and blue LEDs,
and wherein the light-sensing signal of the sensed portion of the color lights corresponds to a red light-sensing signal generated by sensing the light intensity of red light and a blue light-sensing signal generated by sensing the light intensity of blue light, and the first light-sensing data correspond to red light-sensing data and blue light-sensing data.

7. The method of claim 1, wherein controlling the electric power comprises:
modulating pulse widths of currents that are applied to the light sources.

8. The method of claim 1, wherein controlling the electric power comprises:
adjusting level of currents that are applied to the light sources.

9. A light source device comprising:
a light source part including a plurality of light sources that generates a plurality of color lights;
a power supply part applying electric power to the light source part; and
a light source control part that controls the electric power by sensing the light intensity of a portion of the color lights.

10. The light source device of claim 9, wherein the light source control part comprises:
at least one color sensor outputting a light-sensing signal by sensing the light intensity of the portion of the color lights;
an amplifier outputting a light-sensing-amplifying signal by amplifying the light-sensing signal;
an analog-digital converter (ADC) outputting first light-sensing data by analog-to-digital converting the light-sensing-amplifying signal;
a calculating part outputting second light-sensing data of a remainder of the color lights, the remainder of the color lights having the light intensities that are non-sensed; and
a controller that controls the electric power by comparing the first and second light-sensing data with light information data that is provided from the exterior.

11. The light source device of claim 10, wherein the light sources include red LEDs, green LEDs and blue LEDs.

12. The light source device of claim 11, wherein the color sensor corresponds to a red color sensor that senses the light intensity of red light, the light-sensing signal corresponds to a red light-sensing signal, and the first light-sensing data corresponds to red light-sensing data.

13. The light source device of claim 12, wherein the calculating part outputs green light-sensing data and blue light-sensing data that are calculated by the following equation:
GD=RD×(b/a)
BD=RD×(c/a)
wherein RD represents the red light-sensing data outputted based on the light intensity of the red light sensed by the red color sensor, GD represents the green light-sensing data, BD represents blue light-sensing data, and a, b and c represent a mixture ratio of the red light, green light, blue light to generate white light.

14. The light source device of claim 11, wherein the color sensor corresponds to a red color sensor that senses the light intensity of red light and a blue color sensor that senses the light intensity of blue light,
and wherein the light-sensing signal corresponds to a red light-sensing signal and a blue light-sensing signal and the first light-sensing data correspond to red light-sensing data and blue light-sensing data.

15. The light source device of claim 10, wherein the controller controls the electric power by modulating pulse widths of currents that are applied to the light sources.

16. The light source device of claim 10, wherein the controller controls the electric power by adjusting level of currents that are applied to the light sources.

17. The light source device of claim 10, wherein the color sensor is disposed on a center of the light source part.

18. The light source device of claim 10, wherein the light source part is divided into a plurality of light-emitting blocks and the color sensor is disposed on a center of each of the light-emitting blocks.

19. The light source device of claim 10, wherein the color sensor is disposed on at least one of edges, side portions, upper portion and lower portion of the light source part.

20. A liquid crystal display (LCD) device comprising:
a light source part including a plurality of light sources that generates a plurality of color lights;
a power supply part applying electric power to the light source part;
a light source control part that controls the electric power by sensing the light intensity of a portion of the color lights;
a receiving container that receives the light source part; and
an LCD panel including a first substrate, a second substrate and a liquid crystal layer interposed between the first and second substrates to display an image using the color lights.
